(19) United States
(12) Patent Application Publication
(10) Pub. No.: US 2015/0013617 A1
(43) Pub. Date: Jan. 15, 2015

(54) PEST BARRIER

(71) Applicant: Henry Joseph Rideout, Hermitage (CA)

(72) Inventor: Henry Joseph Rideout, Hermitage (CA)

(21) Appl. No.: 14/280,453

(22) Filed: May 16, 2014

Related U.S. Application Data
(60) Provisional application No. 61/824,913, filed on May 17, 2013.

(51) Int. Cl. A01K 29/00

(52) U.S. Cl. CPC A01K 29/00
USPC 119/712

(57) ABSTRACT

A pest barrier comprises a back plate having a top and bottom ends and a channel formed by front and rear walls with a bottom arcuate base therebetween. The pest barrier further includes an arcuate top cap extending between the top of the back plate and the front wall such that the rear wall of the channel is located between and spaced apart from the back plate and the front wall of the channel. The rear wall includes a free distal end spaced apart from the arcuate top cap back plate to provide a gap therebetween. A kit for forming a pest barrier comprises at least two pest barrier members and a connector for securing the at least two pest barrier members to each other.

### BACKGROUND OF THE INVENTION

1. Field of Invention

The present invention relates generally to a pest control device and particularly to a pest barrier that prevents the entry of the pests inside a building and also poisons them without endangering children or domestic animals.

2. Description of Related Art

Many types of insects are considered to be undesirable in homes or other buildings. In particular, along the west coast of North America, as well as the east coast includes by many such pests as the European earwigs. Many other pests such as centipedes, cockroaches and the like exist and may problematically infiltrate into the interior of houses and other buildings. These pests find their way inside many types of buildings and crawl in every nook and corner and once settled inside building, pests can probably find everything it needs to survive and multiply quickly. No matter how neat and clean is the place, the pest will likely locate the food, water, warmth and dark hiding places it needs to live and breed. Pests, once settled inside a building, may threaten the sanity and health of the occupants.

Previous attempts have been made to prevent or control the infiltration of insects into buildings. In particular, pesticide sprayers may be utilized to kill these insects, however, such sprays may only be successful at killing a portion of the insects and do not prevent new insects from infiltrating into the building. Furthermore, such sprays may not be safe for children or even adults at times. Additionally, traps have also be utilized to control pests, however such traps are limited to a specific location and are therefore not able to protect the entire building. Conventional traps are also not capable of preventing an insect from getting into the building, but rather are more concerned with removing the insects once they are already inside the building.

### SUMMARY OF THE INVENTION

According to a first embodiment of the present invention there is disclosed a pest barrier for preventing entry of pests inside a building comprises a back plate having a top and bottom portions, wherein the back plate is adapted to be fixed firmly along the base of the external wall of a building and the bottom portion is securable within the ground surrounding the external wall of the building. The pest barrier further includes a ground plate extending from the back plate at a location between the top and bottom portions and is adapted to lie proximate to the ground and a semi-tubular portion extending from the top portion of the back plate having a distal end which is curved inwardly towards the back plate, wherein the distal end is spaced apart from the back plate to provide a gap between the semi-tubular portion and the back plate and ground plate.

The semi-tubular portion may be formed of front and rear planar portions with top and bottom semi-circular sections therebetween. The top semi-circular section may extend from the back plate. The bottom semi-circular section may include a barrier wall extending substantially upwardly therefrom.

The rear planar portion may include at least one fin extending towards the front plate. The fins may have an arcuate cross-section.

The ground plate may include a downwardly turned distal end. The ground plate may include a plurality of fastener bores for securing to a ground surface with fasteners.

According to a further embodiment of the present invention there is disclosed a pest barrier comprising a back plate having a top and bottom ends and a channel formed by front and rear walls with a bottom arcuate base therebetween. The pest barrier further includes an arcuate top cap extending between the top of the back plate and the front wall such that the rear wall of the channel is located between and spaced apart from the back plate and the front wall of the channel. The rear wall includes a free distal end spaced apart from the arcuate top cap back plate to provide a gap therebetween.

The bottom arcuate base of the channel may include a barrier wall extending substantially upwardly therefrom. The rear wall of the channel may include at least one fin extending towards the front wall. The fins may have an arcuate profile.

The pest barrier further comprises a ground plate extending from the back plate at a location between the top and bottom portions wherein the ground plate may be adapted to lie proximate to the ground. The ground plate may include a downwardly turned distal end. The ground plate may include a plurality of fastener bores for securing to a ground surface with fasteners.

The back plate may be adapted to be secured to a structure. The arcuate base of the channel may be adapted to receive and retain an effective amount of an insect repelling substance.

According to a further embodiment of the present invention there is disclosed a kit for preventing entry of pests inside a building comprising at least two pest barriers and a connector for securing the at least two pest barriers to each other. Each pest barrier comprises a back plate having a top and bottom portions, wherein the back plate is adapted to be fixed firmly along the base of the external wall of a building and the bottom portion is securable within the ground surrounding the external wall of the building. The pest barrier further includes a ground plate extending from the back plate at a location between the top and bottom portions and is adapted to lie proximate to the ground and a semi-tubular portion extending from the top portion of the back plate having a distal end which is curved inwardly towards the back plate, wherein the distal end is spaced apart from the back plate to provide a gap between the semi-tubular portion and the back plate and ground plate.

According to a further embodiment of the present invention there is disclosed a kit for forming a pest barrier comprising at least two pest barrier members comprising a back plate having a top and bottom ends and a channel formed by front and rear walls with a bottom arcuate base therebetween. The pest barrier further includes an arcuate top cap extending between the top of the back plate and the front wall such that the rear wall of the channel is located between and spaced apart from the back plate and the front wall of the channel. The rear wall includes a free distal end spaced apart from the arcuate top cap back plate to provide a gap therebetween. The kit further comprises a connector for securing the at least two pest barrier members to each other.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of the pest barrier for use in exterior of the building according to one embodiment of the present invention

FIG. 2 is a perspective view of the two pest barriers as being connected to each other for use in exterior of the building according to one embodiment of the present invention.

FIG. 3 is a perspective view of the pest barrier for use in interior of a building according to one embodiment of the present invention.

FIG. 4 is an illustration of a method of preparing the exterior of a building for the installation of a pest barrier according to one embodiment of the present invention.

FIG. 5 is a perspective view of a pest barrier according to a further embodiment of the present invention.

FIG. 6 is an illustration of the apparatus of FIG. 3 applied to a wall.

### DETAILED DESCRIPTION

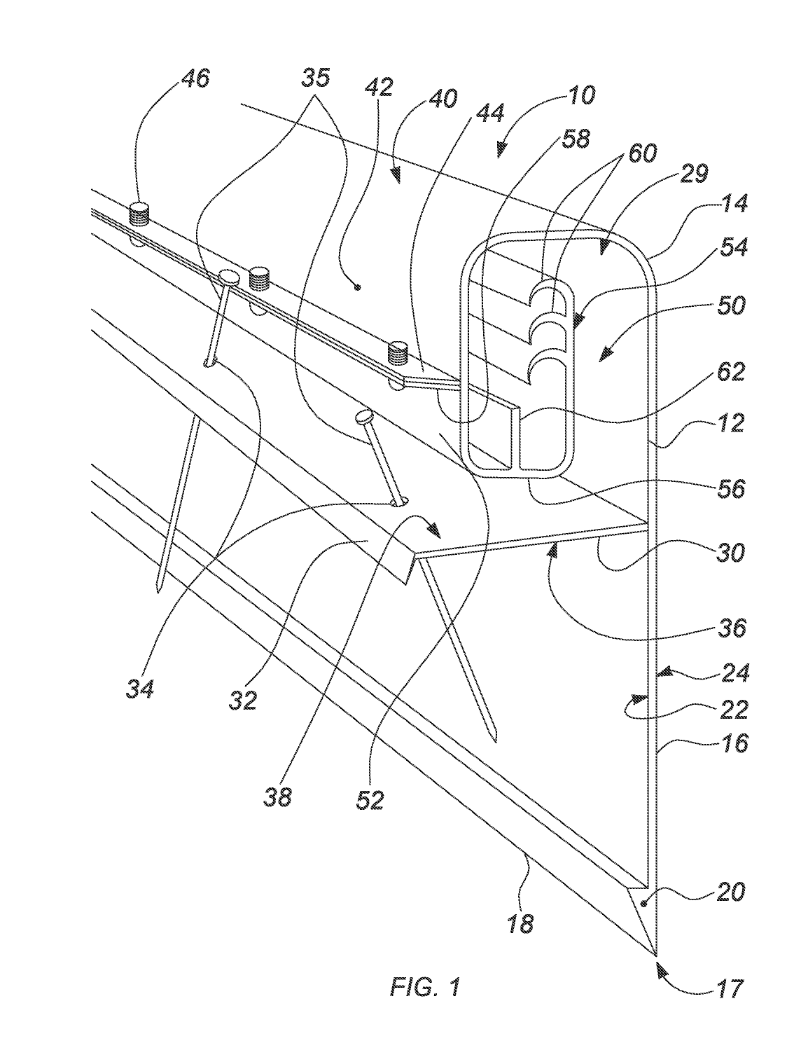

Referring to FIG. 1, an apparatus for preventing entry of pests inside a building according to a first embodiment of the invention is shown generally at 10. The pest barrier 10 mainly comprises a back plate 12 having top and bottom portions, 14, and 16, respectively and having a ground plate 30 extending therefrom between the top and bottom portions 14 and 16. The pest barrier 10 further includes a semi-tubular portion 29 extending from the top portion 14 of the back plate to form a trap for insects and other pests. The back plate 12 of the pest barrier 10 may be fixed or otherwise located along the base of the external wall of a building to provide a continuous barrier therearound.

As set out above, the back plate 12 extends between top and bottom portions 14 and 16 and side ends 17 (only one side end shown in FIG. 1). The back plate 12 has front and rear surfaces 22 and 24 wherein the rear surface is substantially flat so as to be applied to the outside surface of a building. The pest barrier 10 may have any length as desired between the side ends 17 to permit it to be applied around a building. By way of non-limiting example, lengths of between 1 and 20 feet (305 and 6100 mm) has been useful, although other lengths may be useful as well. The bottom portion 16 includes a bottom edge 18 which may optionally have a wedge shaped profile 20 to facilitate retention within a soil formation as will be described more fully below.

The back plate 12 may be formed of any suitable material, such as, by way of non-limiting example, plastic, metal or composite materials and may be formed by any conventional means, such as, by way of non-limiting example, moulding, machining, extrusion, or the like. The back plate may have any thickness sufficient to provide adequate strength to the pest barrier 10 such as, by way of non-limiting example, approximately ¼ inches (6 mm).

The ground plate 30 extends substantially perpendicularly from front surface 22 of the back plate 12 at a position between the top and bottom portions 14 and 16. The ground plate 30 may be co-formed with the back plate or may be connected thereto after forming by any known method, such as, by way of non-limiting example, adhesives, fasteners or welding. The ground plate 30 extends to a distal end 32 having a downturned lip and includes a plurality of fastener bores 34 extending therethrough. The downturned lip prevents insects and the like from crawling under the ground plate 30 as well as reducing moisture from being trapped thereunder. The fastener bores permit fasteners such as ground stakes 35 to be passed therethrough to fasten the ground plate 30 to the ground.

The back plate includes an arcuate portion 40 or top cap located at a topmost edge thereof extending above the ground plate 30. The arcuate portion 40 extends to a front plate 42 comprises a substantially planar member in parallel spaced apart relation to the back plate 12 above the ground plate 30. The front plate 42 may be spaced apart from the back plate by a distance sufficient to prevent insects and other pests from crawling therebetween such as, by way of non-limiting example, a distance of approximately 3 inches (76 mm).

The pest barrier 10 further includes an inner channel 50 formed of a substantially u-shaped member having front and rear walls, 52 and 54, respectively with a bottom arcuate portion or base 56 therebetween. As illustrated in FIG. 1, the front wall 52 of the inner channel 50 may be connected to the front plate 42 by mating flanges 58 and 44, respectively by fasteners 46 or the like. Optionally, the front plate 42 and the front wall 52 may be co-formed with each other. The rear wall 54 of the inner channel includes at least one arcuate fin 60 extending therefrom in a direction towards the front wall 52. As illustrated the pest barrier 10 includes 3 arcuate fins 60 however it will be appreciated that other quantities may be useful as well. The inner channel 50 further includes an upstanding dividing wall 62 extending from the arcuate portion 56.

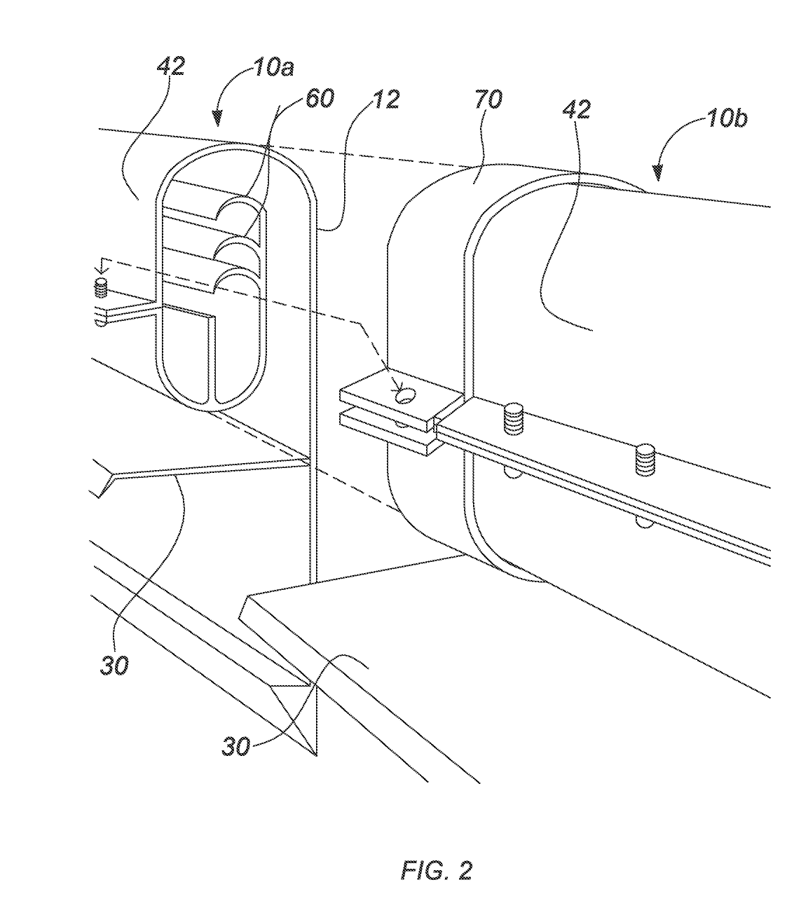

With reference to FIG. 2, two adjacent pest barriers 10 may be connected to each other for use in exterior of the building according to one embodiment of the invention. In particular, two identical pest barriers 10a and 10b may be joined to each other with a collar 70 corresponding to the outer profile of the pest barrier so as to span a gap between the two pest barriers and thereby interlink them. There may be any number of such pest barriers 10 joined together using screws for covering a larger area. All the connecting portions between the pest barriers 10 and collars 70 may have rubberized edges or seals to line up, fit and seal properly or may optionally be sealed with a sealant such as silicone or expanding foam by way of non-limiting example. Due to modular design, the pest barrier 10 may be fitted inside or outside a building of any dimension and is more natural, safe and aesthetically appealing.

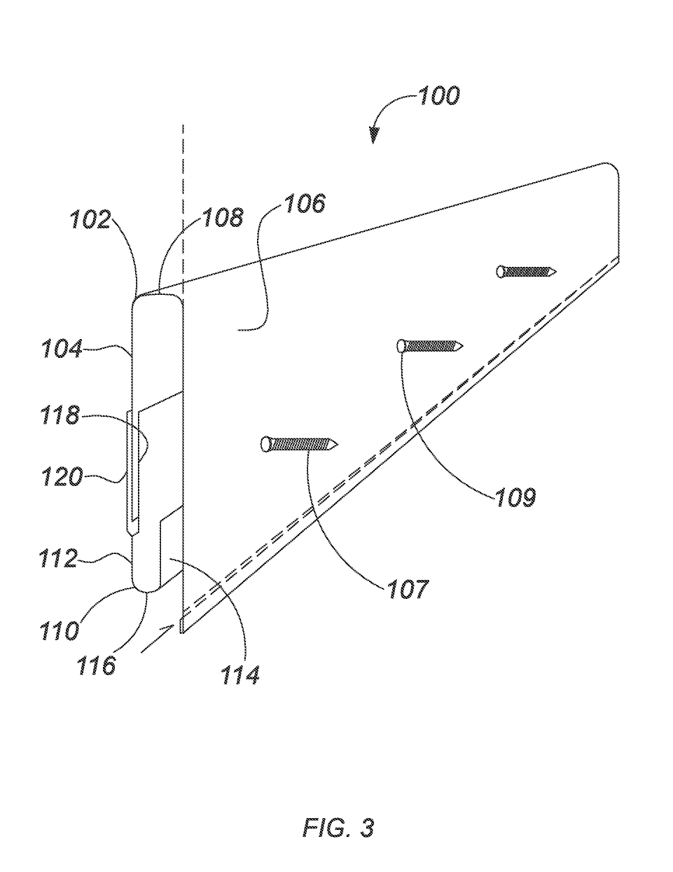

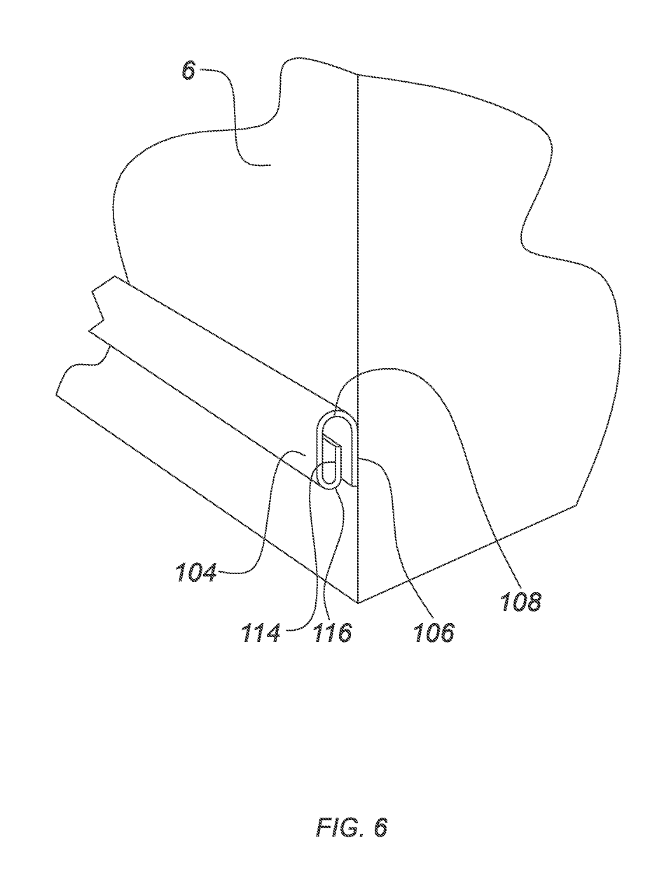

With reference to FIG. 3, a perspective view of an alternative embodiment of the present invention is illustrated generally at 100. The pest barrier 100 comprises a first u-shaped channel 102 securable to a wall with an interconnected second u-shaped channel 110. The first u-shaped channel 102 comprises front and rear walls, 104 and 106, respectively with an arcuate portion 108 therebetween. As illustrated in FIG. 3, the rear wall 106 may be secured to a wall (not shown) by fasteners 107, such as screws or the like passing through fastener bores 109. The second u-shaped channel 110 is formed of front and rear walls, 112 and 114, respectively with an arcuate portion 116 therebetween. The front wall 112 is split into first and second parallel spaced apart portions, 118 and 120, respectively to receive a bottom end of the front wall 104 of the first u-shaped channel 102 therein. In such a way, the first and second u-shaped channels 102 and 110 may be interlocked to form a shape similar to as set out above. The pest barrier 100 will be useful for location along an interior or exterior wall of a building as illustrated in FIG. 6.

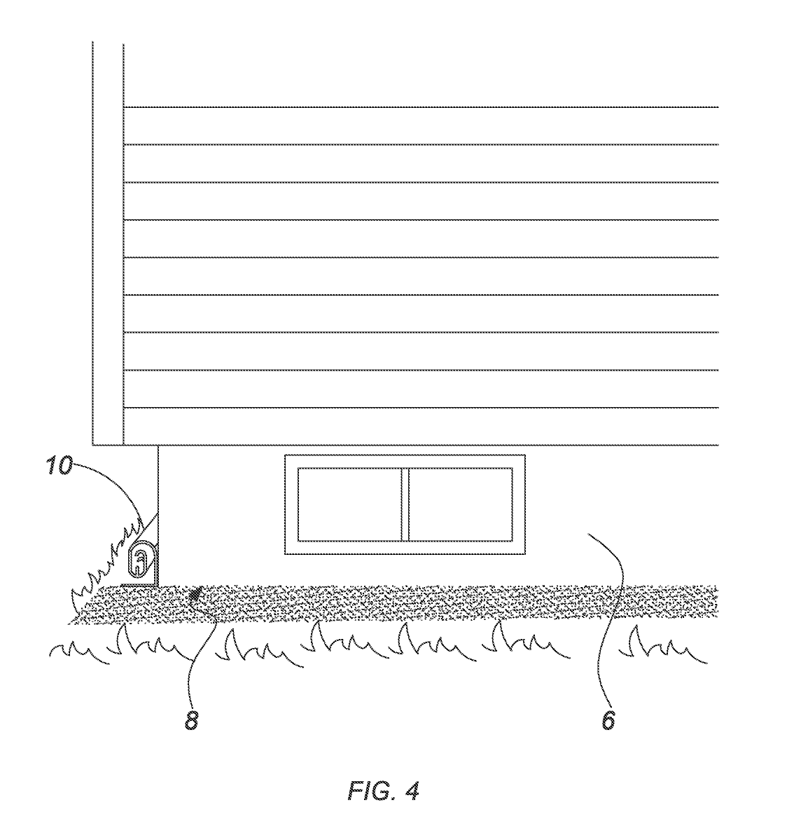

With reference to FIG. 4, in operation, the pest barrier may be installed around the exterior of a building by first removing materials outside the perimeter of the building that could provide harborage, such as ivy growing up walls, ground cover, bark mulches, debris (especially leaves in gutters), wood piles, leaf litter, piles of newspapers, or other organic matter by any commonly known means, such as a shovel or the like to form a strip of soil 8 around the wall 6. Thereafter, a layer of Boric acid may be applied to the top of the soil 8. Optionally, a depression approximately six inch deep and 12 inch wide may be dug all around the external perimeter of the wall of the building and thereafter filled with sand to provide a better draining surface free of organic material. Each pest barrier may be located against the wall and pushed downward to drive the bottom edge 18 into the soil 8. Thereafter fasteners 35 may be driven through the fastener bores to secure the pest barrier to the ground and additional best barriers installed and secured to each other as set out above. Once installed properly, the pest barrier will discourage all kinds of pests from crawling inside the building.

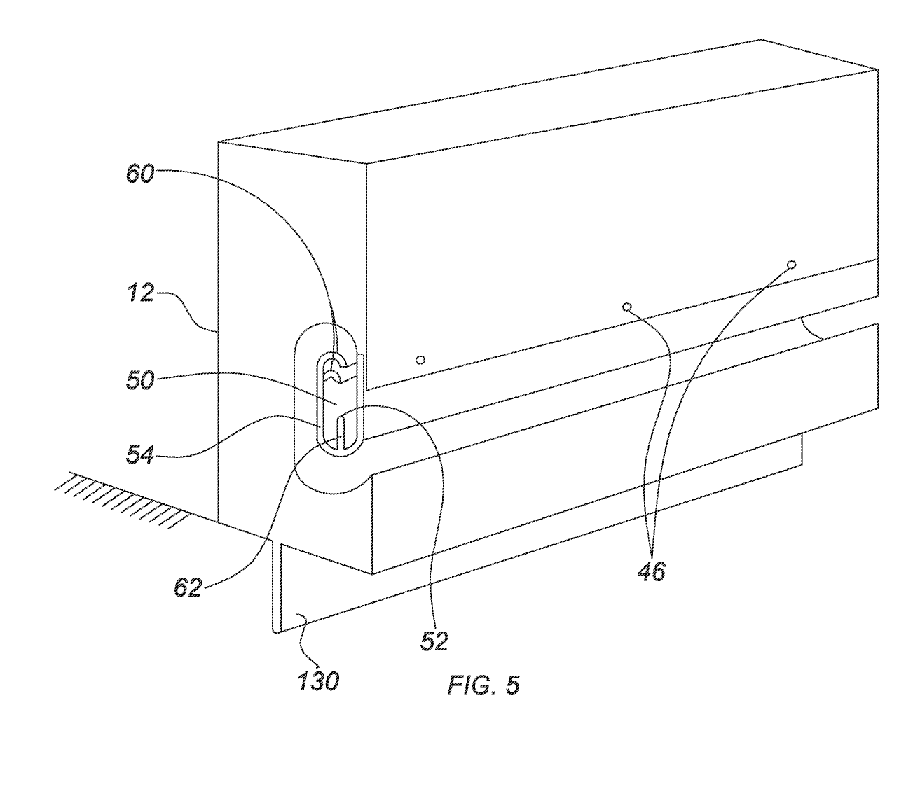

Turning now to FIG. 5, the back plate 12 may be thickened to provide a dividing barrier for a garden or the like. Such a back plate 12 ay extend substantially above the channel 50 and may optionally be decorated as desired by a user.

Boric acid may be placed under the full width of the ground plate 30 to ensure it doesn't become a haven for pests to breed. The slant in the ground plate 30 also prevents water retention due to rain. As the pest barrier 10 is to be used in and around any residential, commercial or public building, it is preferred that a natural non-toxic pesticide such as boric acid should be used to prevent any eventualities. The boric acid may be disposed inside the inner channel 50 and then covered completely hidden from children and pets. As the pests crawl inside the pest barrier 10 to invade a house or any building, they crawl around the inner channel 50 to move on, but have to cross the boric acid powder before reaching the basement wall. Boric acid powder is deadly to any insect such as earwigs cockroaches, fleas, centipedes, son bugs etc. that like dark places. As the insects travel through the boric acid, the acid adheres to their legs. When the insects groom themselves, they then ingest the poison, which causes death three to ten days later of starvation and dehydration. As long as the material is not allowed to become wet, its continuous presence ensures that hatching insects, which sprays commonly spare, are exposed and die.

Although borax is safe to humans, scientists suggest it should not be inhaled by humans. In case the boric acid or any other pesticide is left exposed in open, it sometimes becomes unsafe e.g. as an exposed line around a building on the ground. Hence the pest barrier 10 acts as a pest hiding cum poisoning device without being dangerous to children/adults. The pest barrier 10 completely covers the interior as well as exterior perimeter of a building and prevents the entry of the pests inside the building. The structure of the pest barrier 10 is specifically designed to capitalize upon the physiology and/or behaviour of pests.

While specific embodiments of the invention have been described and illustrated, such embodiments should be considered illustrative of the invention only and not as limiting the invention as construed in accordance with the accompanying claims.

What is claimed is:

1. A pest barrier comprising:
a back plate having a top and bottom ends;
a channel formed by front and rear walls with a bottom arcuate base therebetween; and
an arcuate top cap extending between said top of said back plate and said front wall such that said rear wall of said channel is located between and spaced apart from said back plate and said front wall of said channel,
wherein said rear wall includes a free distal end spaced apart from said arcuate top cap back plate to provide a gap therebetween.

2. The pest barrier of claim 1 wherein said bottom arcuate base of said channel includes a barrier wall extending substantially upwardly therefrom.

3. The pest barrier of claim 1 wherein said rear wall of said channel includes at least one fin extending towards said front wall.

4. The pest barrier of claim 3 wherein said at least fin has an arcuate profile.

5. The pest barrier of claim 1 further comprising a ground plate extending from said back plate at a location between said top and bottom portions, said ground plate being adapted to lie proximate to the ground; and

6. The pest barrier of claim 5 wherein said ground plate includes a downwardly turned distal end.

7. The pest barrier of claim 5 wherein said ground plate includes a plurality of fastener bores for securing to a ground surface with fasteners.

8. The pest barrier of claim 1 wherein said back plate is adapted to be secured to a structure.

9. The pest barrier of claim 1 wherein said arcuate base of said channel is adapted to receive and retain an effective amount of an insect repelling substance.

10. A kit for forming a pest barrier comprising
at least two pest barrier members comprising:
a back plate having a top and bottom ends;
a channel formed by front and rear walls with a bottom arcuate base therebetween; and
an arcuate top cap extending between said top of said back plate and said front wall such that said rear wall of said channel is located between and spaced apart from said back plate and said front wall of said channel,
wherein said rear wall includes a free distal end spaced apart from said arcuate top cap back plate to provide a gap therebetween; and
a connector for securing said at least two pest barrier members to each other.
